(19) United States
(12) Patent Application Publication
(10) Pub. No.: US 2012/0283987 A1
(43) Pub. Date: Nov. 8, 2012

(54) FMCW DISTANCE MEASURING METHOD AND DEVICES

(75) Inventors: Erik Bert Busking, Den Haag (NL); Franciscus Hedrikus Elferink, Noordwijkerhout (NL); Frank Ernst Antoine Van Den Hoef, Gouda (NL)

(73) Assignee: Nederlandse Organisatie voor toegepast-natuurweten schappelijk onderzoek TNO, Delft (NL)

(21) Appl. No.: 13/501,770

(22) PCT Filed: Oct. 14, 2010
(86) PCT No.: PCT/NL10/50677

§ 371 Date: Jun. 28, 2012

(30) Foreign Application Priority Data
Oct. 14, 2009 (EP) 09173013.5
Jun. 24, 2010 (EP) 10167142.8

(51) Int. Cl. G01B 15/00; G06F 15/00

(52) U.S. Cl. 702/159

(57) ABSTRACT

A method of measuring the distance uses a terminal A and a terminal B, each terminal comprising an FMCW generator for generating a signal having a predetermined frequency to time function. Terminal A transmits a transmit signal in transmit periods, which alternate with mute periods without transmission. Terminal B shifts the received signal in time from a transmit period to a mute period, for example by generating a local periodic FMCW signal, determining an adaptation of the timing of that local periodic FMCW that is needed to bring it into a predetermined timing relation to the received signal and applying the adaptation in the mute period. Terminal B transmits the shifted signal, which is received by the receiver of terminal A. Terminal A measures the frequency offset between its own transmit signal and the signal received from terminal B and calculates the distance between terminal A and terminal B from that measured frequency offset, taking into account said predetermined time offset performed in terminal B. Preferably, the transmit signal is constituted by alternating a transmit period, including n cycles of the signal generated by the FMCW generator, and a mute period corresponding with n cycles of that signal, n being at least 1.

### FIELD OF THE INVENTION

The present invention relates to measuring the distance between terminals, a terminal for performing such measurements and a system comprising such terminals. More in particular, the present invention relates to a method for measuring the distance between a tag A and a tag B, and to tags suitable for carrying out the method.

### BACKGROUND

British Patent GB 1 219 410 discloses an FMCW (frequency modulation continuous wave) secondary radar system in which a transponder (on another aircraft or on the ground) returns the incoming signal with a frequency-shifted carrier, and the frequency modulation on the output of the detector is discriminated to give velocity and/or distance. The frequency-shift at the transponder may be height-coded and the system may be utilized for anti-collision protection. Timesharing may be adopted to facilitate multistation operation. To avoid synchronous modulation very low-frequency noise modulation may be added. Directional emission may be utilized. The frequency modulation may be sinusoidal or sawtooth.

British Patent Application GB 2 243 739 discloses a technique for short range distance measurement using sub-microwave radio frequency signals in which the distance between a measurement unit and a co-operative active target unit is determined as follows: The measurement unit transmits a carrier signal which is frequency modulated with a low frequency modulation signal. This is received by the target unit which applies a small frequency shift to the signal and re-transmits it. The measurement unit receives the frequency shifted signal and mixes it with its transmitted signal to form a further frequency modulated signal in which the carrier frequency is equal to the frequency shift applied by the target unit and the modulation signal is at the frequency of the transmitter modulation and takes a form dependent on the round trip delay between measurement and target units and hence distance. The nature of the dependence is determined by the modulation waveform. If this is sinusoidal, the modulation amplitude is directly proportional to distance. By measuring this amplitude the distance can thus be determined. As a result of the frequency shift in the target unit, forward and return paths can be separated and therefore operation at sub-microwave radio frequencies is possible.

U.S. Pat. No. 5,442,357 discloses a control circuit of a radar transponder which produces pulses when the radar transponder detects a radio wave from a search radar. The pulses are sent to a sweep signal generator in which sawtooth waves are obtained through a first constant current circuit for linearizing the voltage-to-time characteristic in a falling portion of a sawtooth. The sweep signal generator further has a second constant current circuit for linearizing the voltage-to-time characteristic in a rising portion of a sawtooth.

These publications utilize techniques which are known from FMCW radar, where a stable frequency signal, frequency modulated by e.g. a saw tooth or (other) triangular modulation signal, is transmitted. A signal reflected from a target object is mixed (multiplied) with the transmitted signal. The reflected signal received tₑ milliseconds later is mixed with a portion of the transmitted signal to produce a beat signal at a frequency f_{b}, which is proportional to the round-trip time tₑ.

Conventionally FMCW uses objects which simply reflect incoming FMCW signals, received from an FMCW transceiver, back to their location of origin. Disadvantageous is the signal attenuation ratio due to a propagation loss ratio of 1/d² over the path d between the transmitter and the object. This attenuation ration applies for both the path from the transceiver to the object and, backwards, the (reflection) path from the object to the transceiver, resulting in an attenuation ratio of 1/d⁴. By using objects which are provided with amplifiers, this attenuation could be compensated.

In practice, however, due to among others problems arising from the large ratio between the power of the signal received by the object and the power with which the transponder transmits the amplified signal back to the radar transceiver, simply amplifying and sending back the received signal without any processing will not work. Such processing could comprise sending back the signal in another frequency band, not interfering with the frequency band of the received FMCW signal. However, this increases frequency usage.

### SUMMARY

It is an object to provide accurate measurements of distance between terminals, wherein interference between transmissions from the terminals is avoided.

A method according to claim 1 is provided. Herein different periods or time slots are used for sending from a radar transceiver terminal to a second terminal and for sending from the terminal to the radar transceiver terminal. A time shifted signal is transmitted in a mute period of the radar transceiver terminal. A terminal which is arranged to transmit a “reflected” signal within the mute period may include a local generator for generating a recovered and amplified reflection signal towards the radar transceiver.

In practical situations all kinds of unforeseen reflections may occur. For that reason the time offset may e.g. correspond to the time needed for transmission over a distance offset of e.g. 10 meters or more. The time offset can easily be compensated in the distance calculation.

It is preferred that the transmit signal is constituted by alternating a transmit period including n cycles of the signal generated by the FMCW generator, n being at least 1. The mute period preferably has a duration of at least one cycle. In an embodiment the duration of the mute period also corresponds with n cycles of the signal.

In an embodiment, wherein the shifted signal is generated by generating a periodic signal in the second terminal (B), the periodic signal having said predetermined frequency to time relation in successive cycles, detecting a timing difference between the periodic signal and the received signal in the transmit period in the second terminal (B), determining an adaption of a timing of the cycles of the periodic signal from the detected timing difference, and deriving the shifted signal from the periodic signal in the mute period, with said adaptation. The timing of the periodic signal may be adapted for example so that cycles of the received signal and the periodic signal during the transmit period start in a predetermined time relation with each other, the resulting adaptation being used also in the mute period. As another example, the adaptation that is needed to realize such a time relation may be determined from the detection in the transmit period and applied in the mute period. In addition to the detection dependent adaptation an additional time shift may even be applied in at least the mute period, the additional time shift having a predetermined length that is known in terminal A, or a length that can be determined in terminal A. Terminal A is able to compensate the distance measurements for any time shift that is known to be applied in terminal B.

To be able to accurately measure the distance d between the radar transceiver terminal and the second terminal, when there is an unknown drift of the local FMCW generator (or oscillator), a synchronization step may be performed. This synchronization may be performed in an iterative process, achieving that, after synchronization, the local FMCW generator runs synchronously, having a predetermined time offset with the FMCW modulation of the received signal.

The FMCW radar transceiver terminal and the second terminal(s) may be tags, may be used in a symmetrical way, i.e. in a mutually equivalent way to another. Such terminals may be incorporated in a network wherein each of the terminals may communicate with each other while, besides, they will be able to measure accurately their mutual distances and, accordingly, their positions relative to another.

The terminals may be tags worn by persons, which could make such system suitable for use in e.g. military operations, fire brigades, police etc. The tag may be a mobile phone, a wristwatch etc.

In this specification and claims the notion FMCW (=Frequency Modulated Continuous Wave) is deemed to include PMCW (=Phase Modulated Continuous Wave). Also possible different signals having a predetermined frequency to time function are deemed to be included in the notion FMCW.

The frequency to time function of the FMCW signal may show a saw tooth shape (having one slope). In an embodiment a triangular (“zigzag”) shape may be used, having two similar slopes in opposite directions, which offers the opportunity to compensate distance calculations for frequency drift.

In addition a frequency offset may be applied. A frequency offset is of e.g. 2 MHz may be used, which can be easily detected. In the distance calculation the influence of this frequency offset is compensated.

The present invention additionally provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet

### BRIEF DESCRIPTION OF THE DRAWING

These and other objects and advantages will become apparent from a description of exemplary embodiments, using the following figures.

FIG. 1 illustrates two terminals and a synchronization action;

FIG. 2 shows an exemplary embodiment of a terminal including synchronization means;

FIG. 3 illustrates a preferred signal transmission scenario;

FIG. 4 illustrates the use of a double sloped triangular FMCW signal.

FIG. 5 shows an exemplary embodiment of a terminal set

FIGS. 5a-i show beat frequency from synchronisation amplitudes as a function of the beat frequency in various cases;

FIG. 6 shows a correlator module.

FIG. 7 shows a terminal

### DETAILED DESCRIPTION OF EXEMPLARY EMBODIMENTS

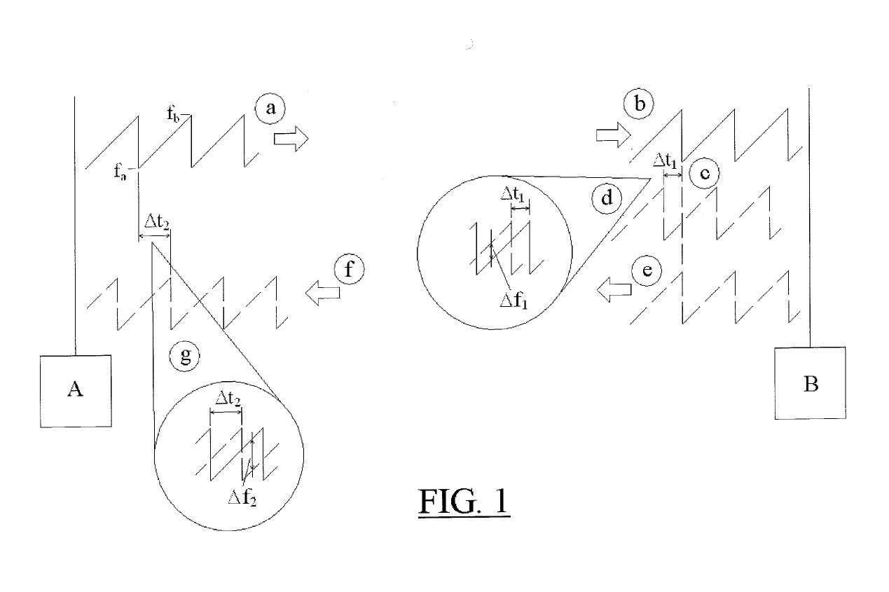

FIG. 1 shows two terminals A and B, each including an antenna. An FMCW generator is provided for generating a signal having a predetermined frequency to time function, represented in FIG. 1 by an FMCW signal which linearly sweeps between a frequency fₐ and a frequency f_{b} under control of an FMCW generator. Each terminal A, B comprises a transmitter for transmitting a transmit signal comprising the FMCW signal. The following steps are performed:
a. terminal A sends an FMCW signal;
b. the signal is received by terminal B;
c. terminal B (continuously) generates a local FMCW signal;
d. terminal B synchronizes the local signal to the received signal by shifting either the received signal or—preferably—the local signal in time such that the local signal has a predetermined time offset compared with the received signal;
e. the local signal, i.e. the signal which was locally generated (c) in terminal B and synchronized (d) relative to the signal received (b) by terminal B from terminal A, is transmitted by terminal B after synchronization (d);
f. this synchronized signal, transmitted by terminal B (e), is received by terminal A;
g. the signal received by terminal A (f) is compared then with (a representative of) the originally sent signal and the distance between terminals A and B is calculated from (measured) Δf₂, i.e. the distance d between terminals A and B is

d[m]=Δt₂ [sec]*c [speed of light in msec⁻¹] [1]
As—common in FMCW based devices—the value of Δf₂ is measured in terminal A rather than the value of Δt₂, d is calculated by

d[m]=Δf₂ [sec⁻¹]*(df/dt)⁻¹ [sec²]*c [msec⁻] [2],
where df/dt represents the frequency sweep of the (saw tooth shaped) FMCW signal, i.e. the slope of the graphical representation of it, as shown in FIG. 1. When, in terminal B, the received FMCW signal is synchronized to the locally generated FMCW signal, viz. by shifting the received FMCW signal towards the “position” of the local FMCW signal, d (in formula [2]) represents the single distance between terminals A and B. Inversely, when—as will be preferred—in terminal B the locally generated FMCW signal is shifted to become synchronous with the received signal, d (in formula [2]) represents the distance A−B−A; in other words d represents twice the distance A−B.

In addition a frequency offset may be applied. In an embodiment the frequency offset is set to e.g. 2 MHz. This (predetermined) value is also discounted in the calculation of the distance between terminals A and B. Such intentional deviation from zero has the advantage that the electronic circuitry works better when the frequency offset is unequal to zero.

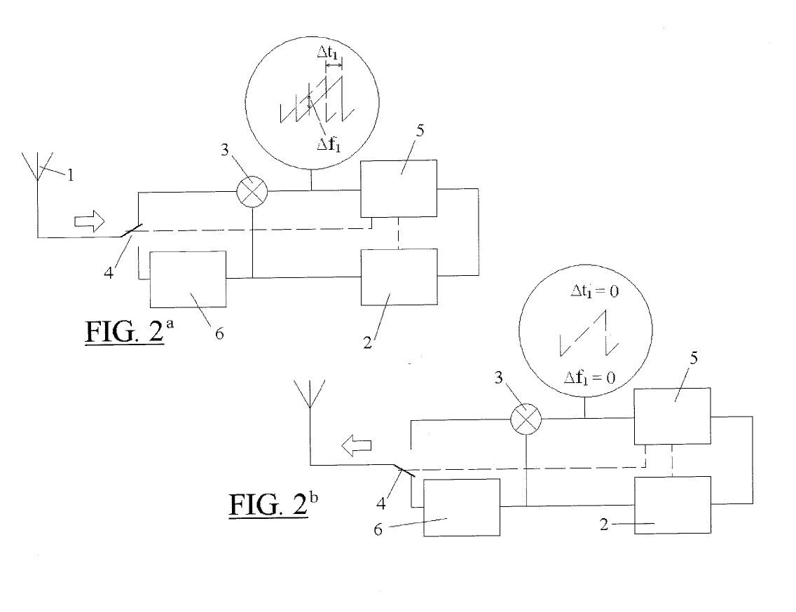

FIG. 2 shows an exemplary embodiment of terminal B (terminals A and B, however, may have similar configurations) including synchronization means. An FMCW signal is received via an antenna 1 of terminal B. A generator 2 within terminal B generates a local FMCW signal. The received and locally generated signals are mixed in a mixer 3. The received signal is applied to the mixer 3 via a switch 4. Both the generator 2 and the switch 4 are controlled by a controller 5. The controller 5 detects the frequency difference Δf₁ or time difference Δt₁ between the received and locally generated signals. in an iterative process the controller 5 shifts the received signal in frequency and/or in time such that the local signal has a predetermined frequency offset and/or time offset compared with the received signal, which offset may be equal to zero of have another predetermined value. As soon as both FMCW signal thus have been synchronized the switch 4 may be turned over, causing that the synchronized FMCW signal is fed to the antenna 1, via an amplifier 6.

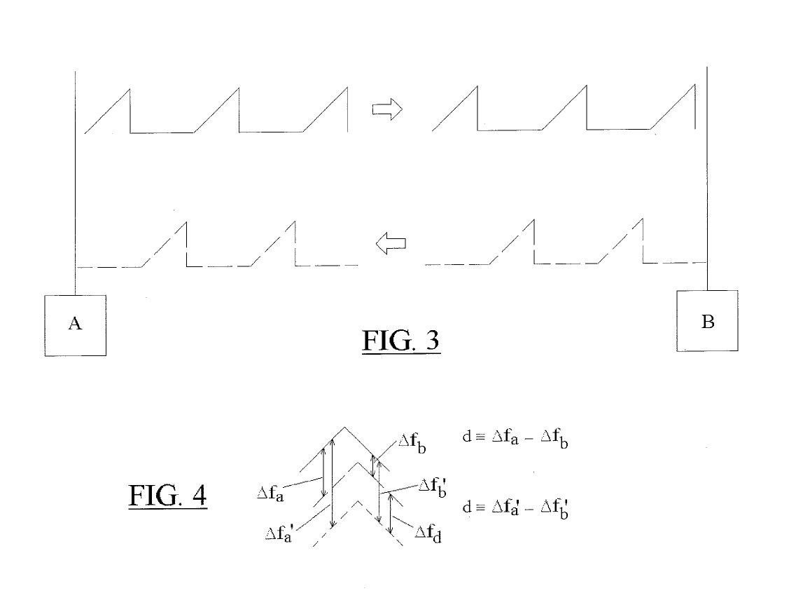

FIG. 3 shows that the terminals A and B are arranged so that the transmit signal of each terminal is constituted by an alternating transmit period, including n cycles of the signal generated by the FMCW generator of terminal A and B respectively, and a mute period corresponding with n cycles of that signal, n being at least 1. In FIG. 3 n=1. So, terminal A and terminal B send their FMCW cycles (n=1 in FIG. 3) in an alternately way. In this way each terminal A and B is able to receive n cycles, synchronize it and switch over (see switch 4 in FIG. 4) transmit the synchronized FMCW cycle(s), without interference.

Transmission in the mute period has the advantage that the same frequencies can be used for the transmit signal from terminal A and the returned signal from terminal B, which reduces bandwidth use. Interference is reduced.

In an embodiment the number of cycles in the transmit period is not equal to the number of cycles in the mute period. A mute period of one cycle may be used for example, as one cycle suffices to determine the distance. In this case a plurality of transmit periods may be used to improve the synchronization before transmission from terminal B.

The predetermined frequency to time function of the FMCW signal may show a saw tooth shape (having one slope and a substantially instantaneous switch back to the starting frequency from the end of the slope), as shown in FIGS. 1-3. However, it is preferred that said predetermined frequency to time function has a triangular (“zigzag”) shape, having two opposite slopes, which offers the opportunity to compensate distance calculations for frequency drift, as can be seen in FIG. 4.

FIG. 4 shows one cycle of a double sloped triangular FMCW signal, i.e.—from top to bottom—a received FMCW signal, a locally generated FMCW signal and a locally generated FMCW signal having a frequency drift Δf_{d}. The distance d is calculated from the values of Δfₐ and Δf_{b}: d=Δfₐ−Δf_{b}. Due to the frequency drift Δf_{d} Δfₐ may have become Δfₐ′ and Δf_{b}Δf_{b}′. As can be seen in FIG. 4, the frequency drift Δf_{d}, however, does not affect the value of d, as de value of Δfₐ−Δf_{b} is equal to the value of Δfₐ′−ΔF_{b}′. Due to this a doubled sloped triangular FMCW form is advantageous over a single sloped, saw tooth shaped FMCW signal form.

Terminals A and B, may have similar configurations. Both may comprise an FMCW generator 2 and optionally an amplifier 6 that are used to transmit an FMCW signal. Controller 5 of terminal B is configured to switch between a sync mode wherein terminal B uses the local FMCW signal to mix down the received signal and a transmit mode wherein the local FMCW signal is used to transmit the FMCW signal back to terminal B. Mixing down with the local FMCW signal reduces the frequency range of the mixed down signal. The FMCW signal may have a sweep of between 10-100 Mhz for example (e.g. 80 Mhz). Terminal B may comprise a filter in mixer 3, as is conventional, to filter the mixed down signal before supplying it to controller 5. The filter may have a bandwidth between 1-10 Mhz (preferably 1-2 Mhz, 1.5 Mhz for example), which is lower than the sweep bandwidth (e.g. at least a factor 10 lower). By mixing with the local FMCW signal the meaningful frequency range mixed signal can be kept within the filter bandwidth. Mixer 3 may be a quadrature mixer, which produces in phase and quadrature phase mixing results. Quadrature mixers are known per se: they may involve mixing the received signal with an in phase version of the local FMCW signal and a quadrature phase FMCW signal. When a quadrature mixer is used, two filters may be used, for the respective signal components. The filter or filters may also be considered as part of controller 5.

Controller 5 of terminal B is configured to control FMCW generator 2 to adapt at least the timing of the local FMCW signal in the sync mode, in order to synchronize with the received signal. Various control strategies are possible. In an embodiment, controller 5 aims to maintain a predetermined time delay and frequency shift between the sweep of the received signal and the local FMCW signal. In this embodiment, triangular sweeps such as shown in FIG. 4 are used, or at least partly triangular sweeps, which comprise a part wherein the FMCW frequency first changes in a first direction at a frequency sweep rate and subsequently changes in a second direction, opposite to the first direction, at said frequency sweep rate. The uppermost and lowest triangular sweeps in FIG. 4 have a mutual time delay and frequency shift for example.

When a predetermined time delay between the frequency sweeps of the received signal and the local FMCW signal and a predetermined frequency shift between the received signal and the local FMCW signal are realized, this has the following effect. Initially first frequency difference D1 occurs between the received signal and the local FMCW signal, while the frequencies of both signals move in the same direction. This difference gives rise to a first mixed down frequency D1. The first frequency difference D1 equals the predetermined frequency shift plus the product of the predetermined time delay and the sweep rate. Next a short transitory time interval occurs wherein the frequency difference changes, when the direction of change of the frequency of one signal has reversed and the other has not. After the transitory time interval a second first frequency difference D2 occurs, which gives rise to a second mixed down frequency D2. The difference D1-D2 between the first and second mixed down frequencies is equal to twice the frequency sweep rate times the time delay between the sweeps of the received signal and the local FMCW signal. This difference is independent of the frequency offset.

The relevant mixed down frequencies are non-zero in the synchronized state with the predetermined a time delay and frequency shift. This reduces the effect of low frequency noise. Mixer 3 may comprise a band pass filter (IF filter) to filter the mixed down signal for input to controller 5, or band pass filters for the in phase and quadrature phase mixing products, if a quadrature mixer is used. Furthermore, the relation between the mixed down frequencies facilitates robust detection of the received signal. The distance between the relevant frequencies makes it possible to eliminate other signals, which do not occur in pairs at this frequency distance.

The predetermined time delay may have a time value which corresponds (via the value of c) to e.g. 10 meters, which (predetermined) value is discounted in the calculation of the distance between terminals A and B. Such intentional deviation from zero has the advantage that the electronic circuitry works better because reflections of objects in the direct vicinity of terminals A and/or B will not or less disturb the interoperation of the terminals.

Controller 5 may be configured to adjust the timing of FMCW generator 2 until frequency peaks at a mutual distance of the frequency sweep rate times the predetermined time delay between the sweeps arise. In this way timing of the received signal and the local FMCW signal may be synchronized with a controlled mutual delay.

If a later cycle of the predetermined local FMCW signal with a predetermined time delay is used to transmit an FMCW signal back to terminal A for distance determination, this will affect the distance determined by terminal A. But as the effect of the time delay is known (a distance correction of the time delay times the signal propagation speed), terminal A may be designed to compensate for the effect. When terminal A determines the distance, terminal A may correct for the delay by subtracting the predetermined delay times the speed of light. The frequency of the local FMCW signal may be controlled based on a frequency reference in terminal, such as a crystal. If desired, controller 5 may be configured to adjust the frequency of FMCW generator 2 based on the average frequency of the peaks, or the frequency of one of the peaks so that a predetermined frequency shift is realized. Similarly, controller 5 may be configured to adapt the sweep rate based on the detected signal.

The frequencies in the resulting mixed down signal may be determined by sampling the mixed down signal during a sweep period of the local FMCW signal and computing the Fourier transform of the sampled signal. Preferably the sampled signal values are digitized using one or more analog to digital converters. Controller 5 may comprise an FFT module for computing the Fourier transform.

The resulting Fourier transform will exhibit amplitude peaks as a function of frequency. Controller 5 may comprise a signal processing circuit configured to detect these peaks and to determine their position for use to control synchronization. When a quadrature mixer is used, and in phase and quadrature phase outputs are used as real and imaginary parts of the input numbers of the FFT, peaks at positive and negative frequency arise independently. Otherwise it may be desirable to use a frequency offset so that the peaks occur both at positive or both at negative frequency. Controller 5 may comprise a signal processing circuit configured to detect these peaks and to determine their position, and a control module, configured to control FMCW generator 2 to adjust the time delay of its local FMCW signal in proportion to a deviation between the distance between the detected peaks and a distance corresponding to the predetermined time delay. In other embodiments the frequencies before and after the transitory time interval may be determined separately, for example using separate FFT computations. In other embodiments the frequency determination need not be linked to the sweep period of the local FMCW signal. It suffices that a signal is derived that is indicative of the difference between the frequency positions of components in the mixed down signal.

In an embodiment, controller 5 may be configured to operate in a search phase before adjusting the synchronization as described, when no frequency peaks of sufficient strength are detected. When there is no synchronization, the mixed down beat frequency between the received signal and the local FMCW signal may lie outside the filter bandwidth of mixer 3. In the search phase, controller 5 may adjust the timing and optionally the frequency in steps until frequency peaks of sufficient strength are detected.

FMCW generator 2 may be configured to sweep the local FMCW signal in periodic cycles, each with an identical sweep, such as the triangular sweep. In this embodiment, controller 5 may be configured to switch terminal B to a transmit mode in a mute period of terminal A, the local FMCW signal being passed to the antenna via amplifier 6 in the transmit mode. Thus, a cycle of the local FMCW signal is transmitted after the local FMCW signal has been synchronized to the received signal in one or more previous cycles. Terminal A may comprise a similar FMCW generator 2, which also produces periodic cycles. Hence terminal A is enabled to determine the distance by mixing the FMCW signal from terminal B with its own FMCW signal in the mute period.

In other embodiments periodic cycles need not be used. One transmitted sweep cycle of the FMCW signal from terminal B, or even only a part of a cycle, suffices for distance determination. As long as controller 5 has determined the local timing of the transmitted signal, it can trigger such a cycle or partial cycle in a predetermined timing relationship with transmission by terminal A. In another embodiment controller 5 may record the received FMCW signal, preferably after normalizing its amplitude, and retransmit the recorded FMCW signal in a predetermined time relation to reception, for example after a delay time interval of predetermined length, or a selected one of a plurality of delay time intervals that start at different predetermined time points relative to reception of the signal from terminal A, controller 5 selecting a delay time interval that at least partly coincides with a mute period of the received signal. Although predetermined time shifts have been used, which allowed terminal A to compensate these time shifts from predetermined information, it should be appreciated that data representing the applied time shift could be transmitted to terminal A and/or terminal B, terminal A using the transmitted data to apply the compensation for the time shift to the distance calculation.

As noted, terminal A and terminal B may have identical components. In this case the difference lies in the selected operation mode. The preceding describes a mode wherein terminal A performs FMCW based distance measurement and terminal B transmits a FMCW in response. The terminals could be switched to an opposite mode wherein terminal B performs FMCW based distance measurement and terminal A transmits a FMCW in response. The distance may be determined by determining the time delay between the FMCW signal in terminal A and the received signal from terminal B. In a further embodiment, the distance may be determined by generating a synchronized FMCW signal in terminal A, as described for terminal B, the controller of terminal A determining the distance from the time offset that needs to be applied to achieve the local synchronized FMCW signal (e.g. the predetermined frequency distance between the detected frequency peaks), compared to the time shift, of any, used to generate the original transmitted signal.

Although examples with sawtooth and triangular FMCW sweeps have been described, it should be appreciated that other sweep shapes may be used, which enable determination of transmission delay from the time shift of the frequency to time dependence.

Summarizing, an embodiment of a method for measuring the distance between a terminal A and a terminal B is provided, wherein each terminal comprises
a generator arranged for generating a signal having a predetermined frequency to time function, called FMCW generator and FMCW signal respectively hereinafter;
a transmitter for transmitting a transmit signal comprising at least one cycle of the FMCW signal,
a receiver for receiving a signal transmitted by the other terminal. During execution of the method terminal A transmits a transmit signal, which is received by the receiver of terminal B;
terminal B shifts the local signal and/or the received signal in frequency and/or in time such that the local signal has a predetermined frequency offset and/or time offset compared with the received signal;
terminal B transmits the shifted signal, which is received by the receiver of terminal A;
terminal A measures the frequency offset between its own transmit signal and the signal received from terminal B and calculates the distance between terminal A and terminal B from that measured frequency offset, taking into account said predetermined frequency and/or time offset performed in terminal B.

In a further embodiment said predetermined frequency to time function has a triangular shape. In another embodiment said predetermined frequency offset is zero. In another embodiment said predetermined frequency offset is a value unequal to zero. In an embodiment the transmit signal is constituted by alternating a transmit period, including n cycles of the signal generated by the FMCW generator, with a mute period corresponding with n cycles of that signal, n being at least 1.

Summarizing, an embodiment of a method for measuring the distance between a terminal A and a terminal B is provided, wherein each terminal comprises
a generator arranged for generating a signal having a predetermined frequency to time function, called FMCW generator and FMCW signal respectively hereinafter;
a transmitter for transmitting a transmit signal comprising at least one cycle of the FMCW signal,
a receiver for receiving a signal transmitted by the other terminal. During execution of the method
terminal A transmits a transmit signal, which is received by the receiver of terminal B;
terminal B shifts the local signal and/or the received signal in frequency and/or in time such that the local signal has a predetermined frequency offset and/or time offset compared with the received signal;
terminal B transmits the shifted signal, which is received by the receiver of terminal A;
terminal A measures the frequency offset between its own transmit signal and the signal received from terminal B and calculates the distance between terminal A and terminal B from that measured frequency offset, taking into account said predetermined frequency and/or time offset performed in terminal B

In an embodiment the method comprises mixing the received transmit signal with the local signal, and adjusting a timing of the local signal dependent on an output signal of the mixer during a period in which the transmit signal is received and to enable transmission of the local signal during a mute period. In a further embodiment the method comprises using a triangular frequency to time relation wherein the frequency first changes in a first direction at a frequency sweep rate and subsequently changes in a second direction, opposite to the first direction at said frequency sweep rate, and detecting a frequency difference between frequency components of the output signal of the mixer and to adjust the timing of the local signal dependent on the frequency difference.

In an embodiment a terminal is provided for use in a system wherein a distance between terminal (B) and a further terminal (A) is measured from a transmission delay of a transmit signal having a predetermined frequency to time relation, the terminal (B) comprising
a receiver for receiving the transmit signal from the further terminal;
a mixer,
a generator configured to generate a local signal having a non-zero time offset compared to the received transmit signal, the generator being coupled to the mixer, the mixer being configured to mix the received transmit signal with the local signal;
a controller with an input coupled to an output of the mixer and a control output coupled to the generator, the controller being configured to adjust a timing of the local signal dependent on an output signal of the mixer during the transmit period and to enable transmission of the local signal during the mute period.

In a further embodiment the transmit signal comprises a triangular frequency to time relation wherein the frequency first changes in a first direction at a frequency sweep rate and subsequently changes in a second direction, opposite to the first direction at said frequency sweep rate, the controller being configured to detect a frequency difference between frequency components of the output signal of the mixer and to adjust the timing of the local signal dependent on the frequency difference.

In the following an embodiment will be described wherein the transmitted signal is also used for data transmission.

In the following, the following abbreviations may be used:
AM Amplitude Modulation
ARTS Active Ranging Transponder System
BPSK Binary Phase Shift Keying
CW Continuous Wave (typically having a constant amplitude)
D-PPM Differential Pulse Position Modulation
D-QPSK Differential Quadrature Phase Shift Keying
DFT Discrete Fourier Transform, often referred to as FFT
FFT Fast Fourier Transform, actually implemented as DFT
FM Frequency Modulation
FMCW FM CW
ISI Inter Symbol Interference
NCO Numerically Controlled Oscillator
OFDMOrthogonal Frequency Division Multiplex
PPM Pulse Position Modulation
QPSK Quadrature Phase Shift Keying
RF Radio Frequency (14 kHz-300 THz)
SNR Signal to Noise Ratio
8-PSK 8 Phase Shift Keying
16-QAM 16 Quadrature Amplitude Modulation

In the figures the following symbols are used:
BFS Beat frequency spectrum
Ampl Amplitude
BFS Beat Frequency from Synchronization sweep
BFD Beat Frequency from Data sweep
BF Beat Frequency
fd the smallest beat frequency step
BFDP Beat Frequency of Dominant Path
SR Response from Synchronization sweep
DR Response from Data symbol sweep
SR Shift register
AB Analysis block

After the synchronization step the terminal B may transmit data to terminal A by modulating the (previously synchronized) local signal by the controller 5, under control of the data to be transmitted from terminal B to terminal A. Several modulation methods are applicable, e.g. OFDM, PPM, D-PPM, PPM/AM and D-PPM/AM. By means of an FFT module in (the receiver part of) terminal A the OFDM, PPM, D-PPM, PPM/AM or D-PPM/AM modulated signal can be converted (demodulated) to data. In this way the same terminal sets may be used for distance measurement and data transfer.

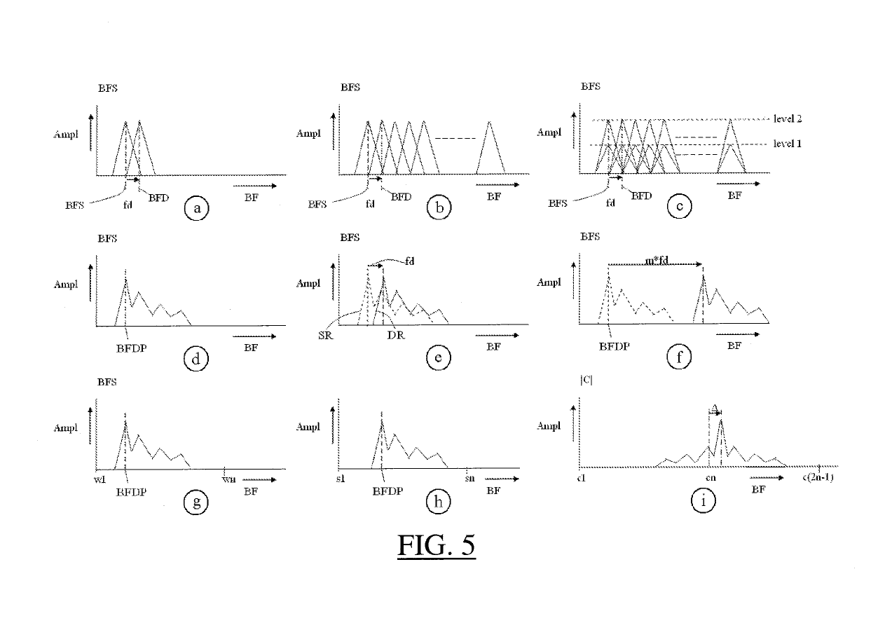

Hereinafter a number of applicable modulation methods are discussed more in detail, with reference to the FIGS. 5a-i.

### OFDM

Orthogonal frequency-division multiplexing (OFDM), essentially identical to coded OFDM (COFDM) and discrete multi-tone modulation (DMT), is a frequency-division multiplexing (FDM) scheme utilized as a digital multi-carrier modulation method. A large number of closely-spaced orthogonal sub-carriers (“bins”) are used to carry data. The data is divided into several parallel data streams or channels, one for each sub-carrier. Each sub-carrier is modulated with a conventional modulation scheme (such as quadrature amplitude modulation or phase-shift keying) at a low symbol rate, maintaining total data rates similar to conventional single-carrier modulation schemes in the same bandwidth.

In good SNR situations, OFDM is certainly applicable. However it is to be realized that in practical situations:
1) The OFDM subcarriers could be modulated BPSK, QPSK, 8-PSK, 16-QAM etc. and received with low Bit-Error Rate, as long as the SNR is sufficient.
2) With OFDM with n subcarriers, the transmitter power has to be divided among these carriers. This reduces the transmitter power per subcarrier by a factor n, worsening link budget.
3) A further lowering of power is dictated by the OFDM crest factor (peak-to-average), forcing the analog chain to be operated at an even lower power level, further worsening link budget.

Points 5 and 6 describe drawbacks of OFDM. However, as mentioned, in good SNR cases OFDM works.

In an embodiment OFDM modulation may be superimposed on the sweep, for example by mixing a base band OFDM signal with a swept signal. In another embodiments the sweep may be replaced by an OFDM signal.

### PPM

Pulse-position modulation (PPM) is a form of signal modulation in which M message bits are encoded by transmitting a single pulse in one of 2M possible time-shifts. This is repeated every T seconds, such that the transmitted bit rate is M/T bits per second. It is primarily useful for optical communications systems, where there tends to be little or no multipath interference.

To overcome bad link budget situations PPM could be applied:
1) PPM provides substantially equal SNR as ranging
2) PPM allows re-use of the RF and baseband circuitry used for ranging.

In FIGS. 5a and 5b, illustrating the method according to the invention, the smallest beat frequency step is represented by fd. A shift can be made in differing magnitudes m*fd,

Let the receiver of terminal A contain an FFT. Let fd be the FFT bin resolution. If there are 256 FFT bins and the receiver resolution accommodates this, one symbol could e.g. represent 8 bits. With 1 kHz sweep rate, 8 kb/s could be transmitted. In general, if there are n FFT bins, one symbol represents ² log n bits and the peak data rate is:

Rp=sweep rate*² log n.

### D-PPM

One of the key difficulties of implementing PPM is that the receiver must be properly synchronized to align the local clock with the beginning of each symbol. Therefore, PPM is often implemented as differential pulse-position modulation (D-PPM), wherein each pulse position is encoded relative to the previous one, such that the receiver must only measure the difference in the arrival time of successive pulses. It is possible to limit the propagation of errors to adjacent symbols, so that an error in measuring the differential delay of one pulse will affect only two symbols, instead of affecting all successive measurements. So in cases where the frequency error of receiver and transmitter is an issue, an offset-independent scheme as D-PPM (compare DQPSK) can be used. This implies that not the absolute positions of the peaks, but only the step-wise differences between the peaks are intended to contain data. The advantage is that this method is tolerant to some loss of exact time-synchronization, thus allows relatively large amounts of data to be transferred without the necessity to synchronize regularly, thereby reducing overhead.

### PPM/AM

Where the SNR is sufficient, additional amplitude modulation can be applied to (D-)PPM modulated FMCW signals, see FIG. 5c.

### Multipath

In case of multipath transmission, the received base band spectrum can have a shape consisting of multiple peaks, as shown in FIG. 5d.

It may be noted that the shape is the result of the channel impulse response. The shape depicted in this figure as an example, is different from an actual impulse response, because it represents the appearance when a modulus operation is applied. After the FFT the beat frequency spectrum is complex and may have to be mathematically treated as such for the most accurate result.

When data are transmitted using PPM or D-PPM, the entire pattern shifts but maintains its shape, see FIG. 5e.

When no action taken, multipath transmission degrades reception at long range: at long range the signal level is low, giving bad SNR and also the delay spread is larger, giving a further decrease of discrimination. These ISI (Inter Symbol Interference) effects are somewhat similar to eye pattern degradation in i.e. WiFi and optical transmission systems.

### Multipath Remedies

Below a few methods to reduce intersymbol interference are described. These methods may be combined in some embodiments.

### Multipath Remedy 1

Apply steps m*fd, which separates the responses but lowers the data rate, illustrated in FIG. 5f.

### Multipath Remedy 2

Apply equalizer-training by transmitting a number of sync sweeps. The receiver performs synchronization to the largest peak simultaneously while averaging out the noise. This could be done either in the complex domain, the modulus domain or the log modulus domain, depending on actual implementation constraints.

### Multipath Remedy 3

The received pattern, from the FFT, is reduced to an impulse function using a correlator module. The correlator module sums a series of signal values, each multiplied by a respective tap factors. The tap factors of the correlator module are first determined by using an ‘inversion’ algorithm. The inversion algorithm aims to deconvolute the effect of multipath transmission. A received signal that results from a known transmitted signal is measured, possibly averaged over a number of cycles, and a set of tap factors is determined that minimizes a measure of difference between the known transmitted signal and the received signal. Inversion algorithms are known from echo cancelling techniques for example.

As a result of correlation the modulus of the beat frequency spectrum is reduced to a single impulse function. In fact the method applied to the modulus of the beat frequency spectrum, is identical to a treatment, as if it were a discrete time function: A discrete time representation of an impulse response can be correlated to its inverse resulting in an impulse function. The effect of equalizer training, the removal of ISI, can be interpreted and implemented as pattern recognition:
The averaged reference pattern, which is obtained on reception of sync sweeps is stored;
The received FFT bin outputs are serialized and led along a correlator;
The largest peak from the correlator module represents the data symbol being received.

Instead of applying correlation to the FFT signal, it may be applied to the time dependent signal, for example before applying the FFT. Correlator modules

### Multipath Remedy 4

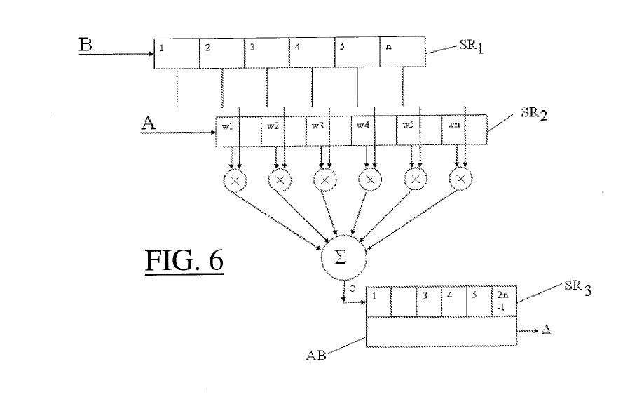

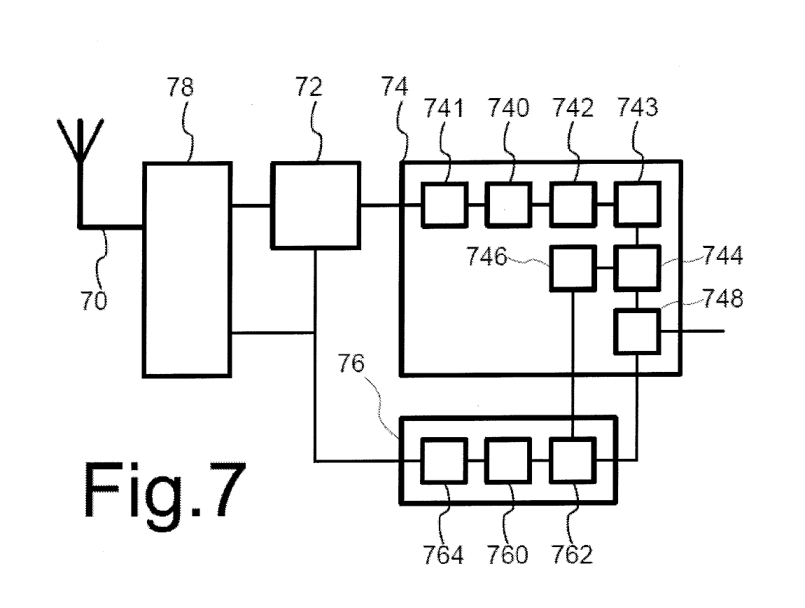

Apply a state of the art correlator module, e.g. having a topology as depicted in FIG. 6. There are two consecutive sweeps. Receiving the first sweep, at the FFT output are n complex values w1 . . . wn. These are stored as a complex vector “A” in a parallel register “a”. Receiving the second sweep, at the FFT output are again n complex values are available, s1 . . . sn, as a complex vector “B”. It may be convenient to store B in a shift register “b”. FIG. 5g shows the effect to vector A after FFT of impulse response of channel. FIG. 5h shows the effect to vector B after FFT of impulse response of channel.

Next, a convolution is performed Conv(A,B*), by stepwise-shifting B through the shift register b in 2n−1 consecutive steps, using the topology. The 2n results are stored as complex vector “C” in a shift register. The vector “C” will contain vectors to be regarded as powers. An analysis block may perform a modulus operation to obtain vector |C| which will in most practical delay spread cases substantially contain 1 symmetric peak. B has no time shift to A. The sole presence of which aids in simplifying demodulation of the DPPM data.

Finally, FIG. 5i depicts a situation in which B is transmitted later in the frame than A, which translates into a peak which deviates an amount Δ from centre cn. Δ represents the relative time step in DPPM. |B has a time shift with respect to A.

It may be noted that the multipliers in the correlation topology perform the operation: z=x·y*, where y* represents the complex conjugate of y.

FIG. 7 shows a terminal B that is configured to perform both synchronization and data transmission. The terminal comprises an antenna 70, a mixer 72, a controller 74, an FMCW generator 76, and a switch 78. Switch 78 may be an electronic switch, comprising one or more transistors. Switch 78 is coupled between antenna 70 on one side and on the other side to an input of mixer 72 and a first output of FMCW generator 76. The output or a second output of FMCW generator 76 is coupled to a second input of mixer 72. Mixer 72 has an output coupled to controller 74. Controller 74 has a control output coupled to FMCW generator 76. Furthermore, controller 74 has a data input/output. Although not shown, it should be appreciated that additionally the terminal may comprise amplifiers, such as a antenna pre amplifier and an output amplifier, and additional intermediate mixing stages. Although single lines have been used to symbolize connections, it should be emphasized that in fact multiple conductors may be used for connections. For example, mixer 72 may be a quadrature mixer, having outputs for in phase and quadrature signal components.

FMCW generator 76 comprises sweep generator module 760, a modulator module 762, and a controllable oscillator 764. Sweep generator module 760 has an output coupled to controllable oscillator 764. Controllable oscillator 764 has an output coupled to switch 78 and to mixer 72. Controller 74 comprises a filter 741, a sampling circuit 740, an FFT module 742, an optional correlator module 743, a frequency detector module 744, a control signal generator 746 and data module 748. Sampling circuit 740 has an input coupled to the output of mixer 72 via filter 741 and an output coupled to FFT module 742. Sampling circuit 740 may comprise an ADC (analog to digital converter). When quadrature signals are used, filter 741 may comprise filter components for in phase and quadrature signals and sampling circuit 740 may be configured to sample both signal components. FFT module 742 has an output coupled to correlator module 743. Frequency detector module 744 has an input coupled to an output of correlator module 743 and an output coupled to control signal generator 746. Control signal generator 746 has outputs coupled to switch 78, controllable oscillator 764 and to sweep generator module 760 via modulator module 762. Data module 748 is coupled to the data input/output of controller 74. Data module 748 has an input coupled to the output of frequency detector module 744 and an output coupled to a control input of modulator module 762.

Part or all of the module of controller 74 and FMCW generator 76 may be implemented as digital signal processing modules. In this case a digital signal processing computer may perform the functions of the various modules under control of stored instructions from program modules for respective functions. Alternatively, part or all of the modules of controller 74 and FMCW generator 76 may be implemented as discrete circuits, on one or more integrated circuits for example.

In operation, controllable oscillator 764 generates a high frequency signal with a frequency controlled mainly by sweep generator module 760. Control signal generator 746 controls switch 78 to switch between a receive state wherein signals from antenna 70 are passed to mixer 72 and a transmit state wherein signals from controllable oscillator 764 are passed to antenna 70. In the receive state, mixer 72 mixes down the received signal from antenna 70 using the signal from controllable oscillator 764. When controllable oscillator 764 is at least roughly synchronized with the received signal, this results in a low frequency signal from mixer, which is filtered and sampled. FFT module 742 computes a Fourier Transform from this signal. Correlator module 743 reduces the effects of multipath transmission and frequency detector module 744 detects the position of frequency peaks in the Fourier transformed signal.

Control signal generator 746 cyclically selects a sweep control signal dependent on the position of frequency peaks. The sweep control signal controls the starting time points of the sweep generated by sweep generator module 760, so that they are synchronized with time points defined by the received signal (allowing for an offset). Because the position of frequency peaks is used for this, information from the entire sweep cycle is used to determine the latter time points.

Form the starting time points control signal generator 746 determines the time intervals of the sweeps that will be transmitted back. At the start and end of these time intervals control signal generator 746 switches control switch 78 to the transmit state and the receive state respectively. Control signal generator 746 does not use the position of the frequency peaks in these time intervals to update the sweep control signal.

When information has to be sent back, data module 748 causes modulator module 762 to shift the starting time points of the sweep in a data dependent way. Different amounts of shift may be used for different data symbols for example. Data module 748 may also use the detected position of the frequency peaks to decode data from the received signal. In an embodiment this is done in selected sweep cycles, control signal generator 746 not using the position of the frequency peaks in these time intervals to update the sweep control signal. In another embodiment, data module 748 selects the amount of shift dependent on the data and causes modulator module 762 to apply the selected amount of shift in one direction and in the opposite direction in respective sweep cycles. This enables terminal A to remove the effect of the modulation on the determination of the distance, by averaging the shifts of its received signal in these sweep cycles.

Although FIG. 7 illustrates one type of modulation, using shifts of the starting time point of the sweep, it should be appreciated that different types of modulation may be used. In this case data module 748 may also control the operation of controllable oscillator 764 to apply frequency, phase and/or amplitude modulation during the sweep. When the received signal comprises OFDM modulation for example, data module 748 may use the output of the FFT module 742 to derive the modulated data. In this way, FFT module 742 may be used both for synchronization and demodulation.

Controllable oscillator 764, with its swept frequency, may be replaced by a combination of a not-swept oscillator, a lower frequency controllable oscillator and a mixer that mixes the signal of the not-swept oscillator with that of the lower frequency controllable oscillator. The controllable oscillator may be a synthesizer circuit that synthesizes the oscillator signal. When no data transmission is needed the modulator module may be omitted.

In an embodiment, a type of modulation is used that maintains a zero average frequency shift during a sweep cycle. Each data symbol may be encoded by a using a pair of modulation symbol with mutually opposite effect on the frequency shift for example. Thus, the effect of modulation on distance measurement may be minimized. In an embodiment, distinct modulation periods and distance measurement periods are used, no modulation being applied to the transmitted local FMCW in the distance measurement cycles. In another embodiment, the controller 74 may be configured to use the demodulated data to counteract the effect of modulation on the received signal before using the received signal to control generation of the local FMCW signal.

It may be noted that the modulation and demodulation could also be used without determining distance between the terminals, even in a terminal without modules for doing so. In this case the FMCW sweep provides for increased robustness of transmission rather than for distance determination.

Summarizing, a method for transmitting data from a terminal B to a terminal A, may be used, wherein each terminal comprising a generator arranged for generating a respective local signal having a predetermined frequency to time function, as well as a transmitter part for transmitting a signal comprising at least one cycle of the local signal, and a receiver part for receiving a signal transmitted by the other terminal. The method preferably comprises the following steps:
a. terminal A transmits a signal A2B, which is received by the receiver part of terminal B;
b. terminal B synchronizes its local signal such that the local signal and the received signal A2B have a predetermined time offset relative to each other;
c. terminal B modulates its local signal by shifting the local signal in frequency and/or in time, under control of the data to be transmitted from terminal B to terminal A;
d. terminal B transmits its local signal, synchronized in step b and modulated in step c, as a signal B2A_{data}, which is received by the receiver part of terminal A.

So in this method terminal B first shifts its local signal in time such that the local signal and the received signal A2B have a predetermined time offset relative to each other. After the synchronization step b the terminal B is ready to transmit data to terminal A, viz. by modulating the (shifted) local signal by shifting the local signal in frequency and/or in time, under control of the data to be transmitted from terminal B to terminal A.

This can be combined with distance measurement, when
b1. terminal B transmits its local signal, synchronized in step b., as a signal B2A_{sync}, which is received by the receiver of terminal A;
b2. terminal A measures the frequency offset between its own local signal and the signal received from terminal B and calculates the distance between terminal A and terminal B from that measured frequency offset, taking into account said predetermined frequency and/or time offset performed in terminal B.

So after the synchronization step b. the terminal B is ready to transmit a signal B2A_{sync} to terminal A, after which terminal A measures the frequency offset between its own local signal and the signal received from terminal B and calculates the distance between terminal A and terminal B from that measured frequency offset.

Preferably, said predetermined frequency to time function has a triangular shape. That is, the frequency first increases linearly with time and then decreases linearly with time. Other shapes of the frequency to time function are also possible, such as a sawtooth shape where the frequency first increases linearly with time and then decreases almost instantaneously to the start value.

Preferably, said predetermined frequency offset is zero.

Preferably, in terminal B the synchronized local signal is modulated by the data using OFDM, PPM, D-PPM, PPM/AM or D-PPM/AM to form said signal B2A_{data}.

The signals may be transmitted between the terminals by wire but are preferably transmitted wirelessly. If wireless transmission is used, the frequencies used are preferably radar frequencies, for example frequencies in the MHz (megahertz) or GHz (gigahertz) range, although the present invention is not so limited.

A computer program product is provided, with a program of instructions for a programmable computer, for making the computer carry out the method as defined above.

A computer program product may comprise a set of computer executable instructions stored on a data carrier, such as a CD or a DVD. The program of computer executable instructions, which allow a programmable computer to carry out the method as defined above, may also be available for downloading from a remote server, for example via the Internet.

The present invention additionally provides a terminal suitable for carrying out the method of the present invention, as well as a system arranged for carrying out the method of the present invention. A terminal according to the present invention may comprise a generator for generating a local signal, a mixer for adding a received and a locally generated signal, and a switch for feeding the received signal from an antenna to the mixer. The terminal may further comprise a controller for controlling the generator and the switch (4), and may preferably further comprise an amplifier for feeding a signal to an antenna. In an advantageous embodiment, the terminal further comprising an FFT unit for demodulating a modulated received signal.

A system according to the present invention may comprise at least two terminals as defined above, as well as antennas connected to the respective terminals.

In other words, summarizing this aspect, a method for transmitting data from a first terminal B to a second terminal A is provided, each terminal comprising
a generator arranged for generating a respective local signal having a predetermined frequency to time function,
a transmitter part for transmitting a signal comprising at least one cycle of the FMCW signal,
a receiver part for receiving a signal transmitted by the other terminal;

The method comprises the following steps:
a. terminal A transmits a signal A2B, which is received by the receiver part of terminal B;
b. terminal B synchronizes its local signal by shifting its local signal in frequency and/or in time such that the local signal and the received signal A2B have a predetermined frequency offset and/or time offset to another;
c. terminal B modulates its local signal by shifting the local signal in frequency and/or in time, under control of the data to be transmitted from terminal B to terminal A;
d. terminal B transmits its local signal, synchronized in step b and modulated in step c, as a signal B2A_{data}, which is received by the receiver part of terminal A.

In an embodiment between steps b. and c.,

b₁. terminal B transmits its local signal, synchronized in step b, as a signal B2A_{sync}, which is received by the receiver part of terminal A;
b₂. terminal A measures the frequency offset between its own local signal and the signal received from terminal B and calculates the distance between terminal A and terminal B from that measured frequency offset, taking into account said predetermined frequency and/or time offset performed in terminal B.

The predetermined frequency to time function may have a triangular shape. Said predetermined frequency offset may be zero.

In step c., in terminal B the synchronized local signal is modulated by the data using OFDM, PPM, D-PPM, PPM/AM or D-PPM/AM to form said signal B2A_{data}.

A terminal (B; A) is provided for transmitting data in accordance with the method according to any of the preceding claims. In an embodiment the terminal, comprises a generator (2) for generating a local signal, a mixer (3) for adding a received and a locally generated signal, a switch (4) for feeding the received signal from an antenna (1) to the mixer (3).

In a further embodiment the terminal further comprises a controller (5) for controlling the generator (2) and the switch (4), the terminal preferably further comprising an amplifier (6) for feeding a signal to an antenna (1).

In a further embodiment the controller (5) is configured for detecting a frequency difference or time difference between a received and a locally generated signal, and preferably is configured for shifting, in an iterative process, a local oscillator signal in frequency and/or in time such that the local signal has a predetermined frequency.

In a further embodiment the terminal further comprises an FFT unit for demodulating a modulated received signal.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A method of measuring the distance between a first terminal and a second terminal, the method comprising the following steps:
transmitting a transmit signal from the first terminal in transmit periods, the transmit periods alternating with mute periods, the transmit signal having a predetermined frequency to time relation;
receiving the transmit signal with a receiver of the second terminal;
generating a shifted signal in the second terminal having a non-zero time offset compared to the received transmit signal and/or compared to a local signal obtained using the received transmit signal, the time offset shifting the shifted signal into one of the mute periods;
transmitting the shifted signal from the second terminal,
receiving the shifted signal with a receiver of the first terminal;
measuring a frequency offset between the transmit signal and the received shifted signal in the first terminal; and
calculating the distance between the first terminal and the second terminal from the measured frequency offset, taking into account said time offset provided by the second terminal (B).

2. A method according to claim 1, wherein the transmit signal has a cyclical frequency to time relation in the transmit periods, including n cycles of the transmit signal, n being greater than one, the mute period having a duration of at least one cycle duration.

3. A method according to claim 1, wherein the shifted signal is generated by generating a periodic signal in the second terminal, the periodic signal having said predetermined frequency to time relation in successive cycles, detecting a timing difference between the periodic signal and the received signal in the transmit period in the second terminal, determining an adaption of a timing of the cycles of the periodic signal from the detected timing difference, and deriving the shifted signal from the periodic signal in the mute period, with said adaptation.

4. A method according to claim 1, comprising generating the local signal in the second terminal, synchronizing the local signal to the received transmit signal, at a predetermined time delay compared to the received transmit signal, the first terminal taking into account said predetermined time delay in the calculation of the distance.

5. A method according to claim 1 wherein the first terminal and the second terminal are tags.

6. A terminal for use in a system wherein a distance between terminal and a further terminal is measured from a transmission delay of a transmit signal having a predetermined frequency to time relation, wherein the further terminal transmits the transmit signal in transmit periods that alternate with mute periods, the terminal comprising
a receiver for receiving the transmit signal from the further terminal;
a generator configured to generate a shifted signal having a non-zero time offset compared to the received transmit signal and/or a local signal obtained using the received transmit signal, the time offset shifting the shifted signal into a mute period in the transmit signal;
a transmitter for transmitting the shifted signal from the terminal.

7. A terminal according to claim 6, wherein the generator is configured to generate a time shifted copy of at least a part of the received transmit signal.

8. A terminal according to claim 1, the terminal comprising
a mixer, the generator having an output coupled to the mixer, the mixer being configured to mix the received transmit signal with the local signal,
a controller with an input coupled to an output of the mixer and a control output coupled to the generator, the controller being configured to adjust a timing of the local signal dependent on an output signal of the mixer during the transmit period and to enable transmission of the local signal during the mute period.

9. A terminal according to claim 8, wherein the transmit signal provides a triangular relation between frequency and time, the being generator configured to generate the local signal with a first signal part wherein the frequency changes in a first direction at a frequency sweep rate and subsequently a second signal part wherein the local signal changes in a second direction, opposite to the first direction, at said frequency sweep rate, the controller being configured to detect a frequency difference between frequency components of the output signal of the mixer due to mixing during the first and second signal part, and to adjust the timing of the local signal dependent on the frequency difference.

10. A terminal according to claim 9, wherein the controller is configured to set the frequency difference to a predetermined value by adjust the timing.

11. A terminal according to claim 1, wherein the controller is configured to switch between a transponder mode, wherein the local signal is used to generate the shifted signal and a distance measuring mode, wherein the local signal is transmitted to the further terminal or another terminal, for obtaining a return signal, the controller being configured to measure a frequency offset between its local signal and the return signal and to calculate the distance between the terminal and the further terminal or another terminal from the measured frequency offset.

12. A terminal according to claim 11, the terminal comprising
a mixer, the generator being coupled to the mixer, the mixer being configured to mix the received transmit signal with the local signal,
a controller with an input coupled to an output of the mixer and a control output coupled to the generator, the controller being configured to make an adjustment of a timing of the local signal dependent on an output signal of the mixer during reception of the return signal and to measure the frequency offset between its local signal and the return signal from the adjustment.

13. A terminal according to claim 1, comprising a data input and a modulator configured to modulate the local signal dependent on data received from the data input.

14. A tag comprising a terminal according to claim 1.

15. A network comprising a plurality of terminals according to according to claim 1.

16. A computer program product comprising a program of instructions for a programmable processor circuit that, when executed by the programmable processor circuit causes the programmable processor circuit to
receiving a transmitted FMCW signal from a further terminal;
generate a shifted FMCW signal having a non-zero time offset compared to the received transmit signal and/or a local signal obtained using the received transmit signal, the time offset shifting the shifted signal into a mute period in the transmit signal;
cause the shifted FMCW signal to be transmitted.
